(19) United States
(12) Patent Application Publication
(10) Pub. No.: US 2009/0255904 A1
(43) Pub. Date: Oct. 15, 2009

(54) ARC SPLITTER ARRANGEMENT FOR AN ELECTRICAL SWITCH

(75) Inventors: Gerald Andre, Erlangen (DE); Thilo Bahlinger, Ruelzheim (DE)

Correspondence Address: DARBY & DARBY P.C., P.O. BOX 770, Church Street Station, New York, NY, 10008-0770, US

(73) Assignee: ABB AG, Mannheim (DE)

(21) Appl. No.: 12/416,252

(22) Filed: Apr. 1, 2009

(30) Foreign Application Priority Data
Apr. 9, 2008 (DE) 10 2008 017 868.3

(51) Int. Cl. H01H 9/44

(52) U.S. Cl. 218/38

(57) ABSTRACT

An arc splitter arrangement for an electrical switch comprises at least two arc splitters composed of a ferromagnetic material disposed parallel to one another, wherein each of the at least two arc splitters has a V-shaped cutout on a narrow face edge forming an inlet area for an arc, and an insulating material at least partially coating at least one side of the arc splitter, wherein the at least one side includes an area located behind the inlet area in an arc running direction, the area being free of, and surrounded by, the insulating material. A service switching device comprises at least one arc splitter arrangement.

Priority is claimed to German Patent Application No. DE 10 2008 017 868.3, filed on Apr. 9, 2008, the entire disclosure of which is incorporated by reference herein.

The invention relates to an arc splitter arrangement for a service switching device, in particular for a circuit breaker, a motor circuit breaker or a contactor, having arc splitters which are arranged parallel to one another.

The invention furthermore relates to a service switching device having an arc splitter stack such as this.

### BACKGROUND

An arc splitter arrangement of this generic type, also referred to as an arc splitter stack or else a deionizing splitter stack, is used in particular in a circuit breaker, a motor circuit breaker or in a contactor, with the aim of disconnecting not only rated currents but also overcurrents and in particular short-circuit currents. It operates in such a way that an arc which is created at a contact point when it opens is introduced as a result of the current forces into the arc splitter stack, in which the arc foot points which are formed on the stationary and moving contact pieces are passed via arc guide rails into the arc splitter stack, in which the arc is split into a plurality of arc elements, thus increasing the arc voltage and limiting the short-circuit current.

One such arrangement is described, for example, in DE 103 12 820.

One problem in the movement of the arc or of the individual arc elements within the arc splitter stack is that, without further measures, the arc can flash over or restrike at the end of the arc splitter stack or else on the side edges, thus preventing current limiting and correct short-circuit disconnection.

In order to comply with the particular requirements, some of which are also contradictory, various solutions have been proposed.

DE 32 47 681 describes an arc quenching chamber which has an arc splitter arrangement whose arc splitters are coated with a material which emits gas or vapour. This material is vaporized under the influence of the arc, as a result of which arc quenching is assisted. However, since the material is consumed, the number of switching operations which can be carried out is limited.

DE 21 33 926 describes an arc splitter arrangement in which individual arc splitters are coated with insulating material at least in the rear section as seen in the arc running direction while, in contrast, other quenching plates which are located between the coated arc splitters are uncoated. The coated arc splitters are partially coated on both sides.

DE 38 18 864 A1 describes the quenching plates being provided on the cathode side with strips which run in the longitudinal direction and have a low electrical work function, wherein magnesium or a magnesium alloy or a material composed of a rare-earth substance are used as the material for the coating. This accelerates the value of the arc. DE 10 2007 005 996.7-34 has proposed that a composite material be used as the coating material, which composite material has specific characteristics and at the same time is electrically conductive. This makes it possible to achieve a high arc migration speed.

### SUMMARY OF THE INVENTION

An aspect of the present invention is to provide an arc splitter arrangement which leads to an improvement in quenching and switching characteristics in comparison to the known arrangements, wherein restrikes and flashovers outside the splitter stack are prevented by the arc being stabilized at the burning point. A flashover between the plates is avoided, and local melting of individual plates is prevented.

According to the present invention, an area which is located behind the inlet area in the arc running direction and is free of the insulating material is formed on at least one broad face of each arc splitter, wherein the insulating material completely surrounds the free area.

Thus, according to the present invention, an area in the form of an island or a zone like an island is left uncoated on each plate, into which uncoated zone the arc is deliberately guided and is preferably intended to burn in the area of the uncoated zone. In this case, it could oscillate in the uncoated area, and local melting can be prevented by the oscillation.

A further preferred refinement of the invention may comprise the area which is not covered by the insulating material, that is to say the area which remains free, being coated with a conductive material which, for example, may be silver.

DE 10 2007 005 996.7-34 describes arc splitters being coated with a composite material composed of at least two components, the first component of which is electrically conductive and has a melting point which is not above the melting point of the material of the arc splitter, and has a vaporization point which is not above the vaporization point of the ferromagnetic material, and the second component of which has a melting point which is above the melting point of the ferromagnetic material and has a vaporization point which is above the vaporization point of the material of the arc splitter.

According to a further embodiment of the invention, a composite material which corresponds to the conditions specified in DE 10 2007 005 996.7-34 can be applied as a coating material in the remaining area which is surrounded by the insulating material. To this extent, with regard to the composite material, this application is part of the present invention.

According to a further refinement of the invention, the insulating coating may have characteristics which emit gas or vapour under the influence of an arc; this promotes current limiting.

### BRIEF DESCRIPTION OF THE DRAWINGS

The invention as well as further advantageous refinements and improvements of the invention, and further advantages, will be explained and described in more detail with reference to the drawings, which illustrates a number of exemplary embodiments of the invention, and in which:

FIG. 1 shows a plan view of an arc splitter stack according to a first embodiment,

FIGS. 2, 3 show plan views of an arc splitter stack according to a second and third embodiment,

FIG. 4 shows a section view through an arc splitter stack along the section line IV-IV in FIG. 1,

FIG. 5 shows a section view through a part of the arc splitter stacks along the section line IV-IV in FIG. 1,

FIG. 6 shows a plan view of an arc splitter stack according to a further embodiment, and

FIG. 7 shows a section view along the section line VII-VII in FIG. 6

### DETAILED DESCRIPTION

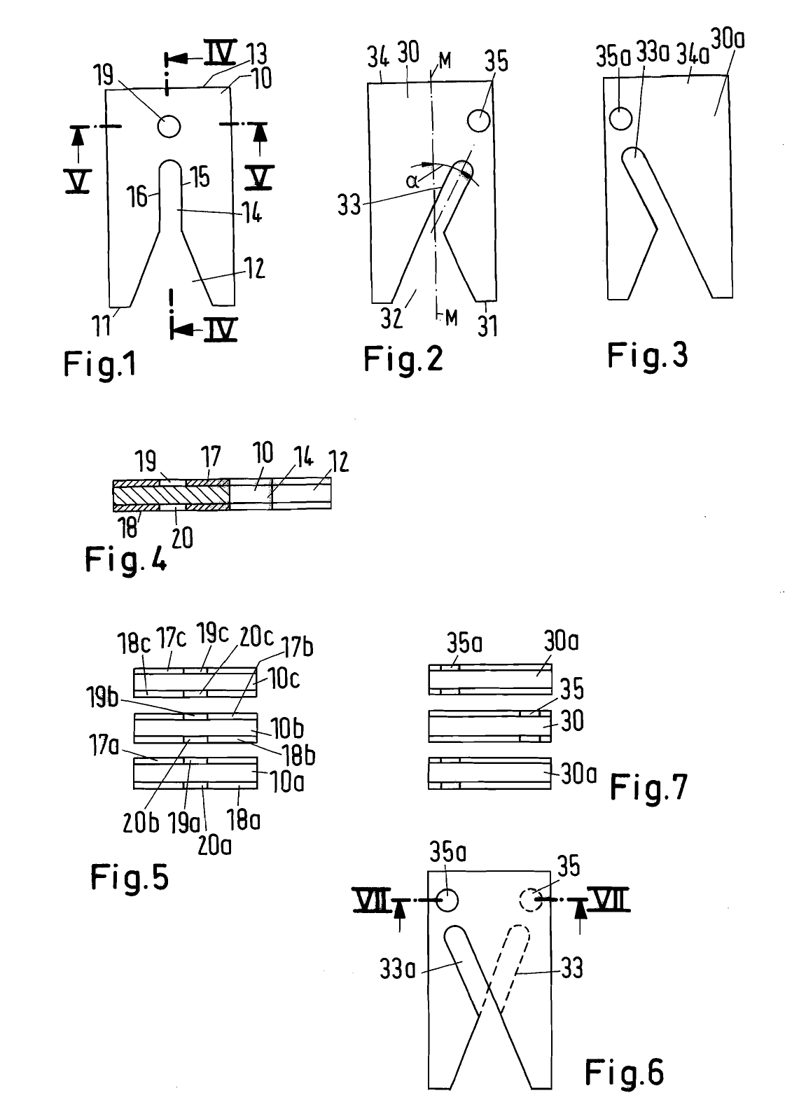

An electrical circuit breaker, which will not be described in any more detail here, but whose construction is known per se, has a contact point with a stationary contact piece and a moving contact piece which is fitted on a contact lever, each of which have associated arc guide rails which run parallel and hold between them an arc splitter stack as shown in FIGS. 1 to 7. The fact that a circuit breaker such as this has a latching mechanism, a switching toggle, a thermal and electromagnetic release as well as connecting terminals, a switching toggle and a capability for mounting on a top-hat profile mounting rail will not be described in any more detail here.

When a short-circuit current occurs, for example, when a switching operation takes place, that is to say the opening of the contact point, the arc foot point of an arc which burns between the stationary contact piece and the moving contact piece is created on the stationary contact piece and on the moving contact piece, with the arc foot points being commutated onto the arc guide rails, and with the arc being driven into the arc splitter stack by electromagnetic forces, which will not be explained in any more detail here.

The arc splitter stack is formed from a plurality of arc splitters which may be designed as illustrated in FIGS. 1 to 3.

In the embodiment shown in FIG. 1, each arc splitter 10 of an arc splitter stack has an elongated rectangular form with a symmetrical, V-shaped cutout 12 being incorporated in the area of the first narrow face edge 11, which is shown at the bottom in FIG. 1, which cutout 12 tapers towards the opposite second narrow face edge 13, as a result of which the V-shape is open towards the first narrow face edge 11. In the embodiment shown in FIG. 1, the V-shaped section 12 has a section 14 in the form of a slot adjacent to it, whose side edges 15 and 16 run at right angles to the narrow face edges 11 and 13; this cutout 14, which is in the form of slot, or slot 14 ends approximately in the third which is adjacent to or is connected to the second narrow face edge 13.

The arc splitter stack is coated on both sides with a layer 17 and 18 composed of insulating material, except for sections 19 and 20 which remain free, are circular in the embodiment shown in FIG. 1, and are arranged on an extension of the centre axis of the V-shaped cutout 12 and of the slot 14.

FIG. 4 illustrates this on the basis of a section view along the section line IV-IV shown in FIG. 1.

FIG. 5 shows a section view along the section line V-V in FIG. 1 with three arc splitters 10a, 10b and 10c which are coated with insulating material 17a, 18a; 17b, 18b as well as 17c and 18c. The uncoated areas 19a, 20a; 19b, 20b as well as 19c and 20c are aligned with one another and lie on an axis which runs at right angles to the arc splitters 10a, 10b, 10c.

When an arc now enters the arc splitter stack, then it is accelerated into the slot 14 and, after overcoming the insulating layer between the base of the slot 14 and the section 19, 20, can then burn in this section 19, 20 of all the arc splitters, see FIG. 5. Because of the surrounding insulating layer, the arc can no longer run back onto the edge of the quenching plate and initiate a restrike, but it burns in a stable form in the splitter stack. In this case, it can oscillate there, thus making it possible to prevent melting of the quenching plate material.

In the embodiment of an arc splitter stack shown in FIG. 2, each individual arc splitter 30 has a cutout 32, which corresponds to the cutout 12, on its first narrow face edge 31, adjacent to which cutout 32 there is a cutout 33 in the form of a slot, which is angled at an acute angle α with respect to the centre axis of the elongated rectangular arc splitter 30, which centre axis runs approximately centrally at right angles to the first narrow face edge 31 and a second narrow face edge 34. In the embodiment shown in FIG. 2, the angle is angled to the right while, in contrast, in the embodiment shown in FIG. 3, the arc splitter 30a is rotated through 180° about the centre longitudinal axis M-M (see FIG. 2), in such a way that the area 33, which is in the form of a slot, is angled to the left there. This type of splitter stack design is used in particular for DC-voltage switching devices.

To this extent, the splitter stack shown in FIG. 2 does not in principle differ from that shown in FIG. 3, but it is in each case used rotated through 180° in an arc splitter stack. The arc splitters 30 shown in FIG. 2 and the arc splitters 30a shown in FIG. 3 are installed, in in each case one refinement of an arc splitter stack, such that the individual slots run parallel to one another.

The arc splitters 30 shown in FIG. 2 and the arc splitter 30a in FIG. 3 are covered by an insulating material which corresponds to the insulating material or the layers 17, 18. An area 35 or 35a, which is uncoated, like the section 19, 20 is located on an extension of the centre axis of the slot 33 of the arc splitter 30 or of the slot 33a of the arc splitter 30a, respectively. The arc is intended to enter the slot 33 via the V-shaped cutout 32, and to jump from there onto the area 35, 35a, and to burn in a stable form in this uncoated area.

FIG. 6 shows the embodiment of the arc splitter stack from above, and FIG. 7 shows a section view of this arc splitter stack along the section line VII-VII in FIG. 6. In the embodiment illustrated in FIGS. 6 and 7, arc splitters 30, 30a as shown in FIGS. 2 and 3 are arranged one above the other. The slot 33 (or the cutout 33) in the arc splitters 30 are shown by dashed lines in the drawing in FIG. 6, while, in contrast, the slot 33a or the cutout 33a in the form of a slot in the arc splitters 30a is shown by solid lines. The area 35 which remains free on the arc splitters 30 is in each case arranged offset with respect to the area 35a which remains free on the arc splitters 30a, corresponding to the illustration shown in FIG. 6 and FIG. 7.

In the embodiment shown in FIG. 6, the obliquely running cutouts 33, 33a in the form of slots are aligned alternately to one side and to the other side.

It is now possible to coat the sections 19, 20; 35, 35a which remain free with electrically conductive materials, by applying silver in these areas; a composite material may, of course, also be used, which is likewise electrically conductive, although less conductive, for example, than a silver layer. In this case, it is also possible to coat that section which is not coated with insulating material on one side of the arc splitter with the electrically conductive layer, and leave this section free on the other side, etc.

The insulating coating may in this case be a material which emits gas, in the same way as the coating within the area 19, 20 or 35, 35a, which is not coated by the insulating material, and this is likewise known per se.

### LIST OF REFERENCE SYMBOLS

| | |
|---|---|
| 10 | Arc splitter |
| 10a | Arc splitter |
| 10b | Arc splitter |
| 10c | Arc splitter |
| 11 | Narrow face edge |
| 12 | V-shaped cutout |
| 13 | Second narrow face edge |
| 14 | Section in the form of a slot, slot |
| 15 | Side edge of 14 |
| 16 | Side edge of 14 |
| 17 | Layer composed of insulating |
| | material |
| 17a | Layer composed of insulating |
| | material |
| 17b | Layer composed of insulating |
| | material |
| 17c | Layer composed of insulating |
| | material |
| 18 | Layer composed of insulating |
| | material |
| 18a | Layer composed of insulating |
| | material |
| 18b | Layer composed of insulating |
| | material |
| 18c | Layer composed of insulating |
| | material |
| 19 | Remaining section |
| 19a | Remaining section |
| 19b | Remaining section |
| 19c | Remaining section |
| 20 | Remaining section |
| 20a | Remaining section |
| 20b | Remaining section |
| 20c | Remaining section |
| 30 | Arc splitter |
| 30a | Arc splitter |
| 31 | First narrow face edge |
| 32 | Cutout |
| 33 | Cutout in the form of a slot |
| 33a | Cutout in the form of a slot |
| 34 | Second narrow face edge |
| 34a | Second narrow face edge |
| 35 | Uncoated area |
| 35a | Uncoated area |

What is claimed is:

1. An arc splitter arrangement for an electrical switch comprising:
at least two arc splitters composed of a ferromagnetic material disposed parallel to one another, wherein each of the at least two arc splitters has a V-shaped cutout on a narrow face edge forming an inlet area for an arc and an insulating material at least partially coating at least one side of the arc splitter, wherein the at least one side includes an area located behind the inlet area in an arc running direction, the area being free of, and surrounded by, the insulating material.

2. The arc splitter arrangement as recited in claim 1, wherein the electrical switch is one of a circuit breaker, a motor circuit breaker, and a contactor.

3. The arc splitter arrangement as recited in claim 1, wherein the area is coated with a conductive material.

4. The arc splitter arrangement as recited in claim 3, wherein the conductive material is silver.

5. The arc splitter arrangement as recited in claim 3, wherein the conductive material is an electrically conductive composite material.

6. The arc splitter arrangement as recited in claim 1, wherein the insulating material is configured to emit a gas or vapour under an influence of an arc.

7. A service switching device, comprising at least one arc splitter arrangement that includes:
at least two arc splitters composed of a ferromagnetic material disposed parallel to one another, wherein each of the at least two arc splitters has a V-shaped cutout on a narrow face edge forming an inlet area for an arc and an insulating material at least partially coating at least one side of the arc splitter, wherein the at least one side includes an area located behind the inlet area in an arc running direction, the area being free of, and surrounded by, the insulating material.

8. The service switching device as recited in claim 7, wherein the service switching device is one of a circuit breaker, a motor circuit breaker, and a contactor.
